(19) United States
(12) Patent Application Publication
(10) Pub. No.: US 2007/0094153 A1
(43) Pub. Date: Apr. 26, 2007

(54) Infrastructure for postage meter communication, accessible through service provider

(76) Inventor: Mark Ferraro, Hamden, CT (US)

Correspondence Address: KENYON & KENYON LLP, 1500 K STREET N.W., SUITE 700, WASHINGTON, DC, 20005, US

(21) Appl. No.: 11/257,663

(22) Filed: Oct. 25, 2005

(51) Int. Cl. G06Q 99/00

(52) U.S. Cl. 705/67

(57) ABSTRACT

A system for providing postal and other services to postal security devices is established in which a secured communication connection is obtained through a service provider. The connection once established provides access to a central postal data center. As part of the authentication of a connection by the service provider, the service provider generates a session key having a discrete time limit. Expiration of the time limit terminates the session key. Security keys are provided to the service provider, with reference to public keys of the service provider, by the data center communication infrastructure.

### BACKGROUND OF THE INVENTION

The present invention relates to a postal infrastructure that provides communication to one or more postal security devices (PSD). More particularly a system is provided for authorizing access to the infrastructure by the user of the PSD through a service provider.

### BRIEF DESCRIPTION OF RELATED DEVELOPMENTS

A high volume postal customer may use a Postal Security Device (PSD) to secure the proof of payment of postal indicia. In an exemplary application, indicia may be applied to mailing items that identifies the value of the postage applied and other information. A customer may purchase postage and the purchased value may be stored in the PSD. As the postage indicia are applied to items, the value applied may be deducted from the stored value. Once postage indicia are applied, the item may then be dropped into the collection stream of the particular postal system and subsequently processed for delivery. The account identification, history and status for a particular PSD may be stored at a remote data center that is part of a postal infrastructure.

In various countries, for example the United States, PSDs may communicate with a remote data center to exchange information related to customer usage and funding for billing purposes and to have postage funds replenished. In the United States, a postal customer generally may add postage to the PSD in two ways. The first is to physically take the PSD to the postal authority, where postage is purchased and added to the PSD.

The second is to remotely add postage over a network, for example, a telephone line with a modem, or the Internet, where the added postage is deducted from an account usually maintained at a remote data center with a meter vendor or a trusted third party administrator, for example, a financial institution. In this case, customer or postal authority access to a meter's accounting system or memory system generally is not possible. Meters or PSDs with this type of communication capability may communicate with a data center or other service providers through a postal infrastructure where the PSD initiates communication.

Since postal security devices are available through distributors other than an original equipment (OEM) meter vendor, related services, such as postal funds downloading, advertisements, software and others may be provided through such distributors and other third party service providers, as well as directly from the meter vendor. In prior art systems, the customer needed to go through the OEM postal infrastructure to be authenticated and authorized and then obtain services from a third party vendor. This requires a separate server to generate and control security keys and to authenticate users coming into infrastructure.

It would be advantageous for a third party service provider to have the ability to authenticate a communication with one or more PSD's and authorize access to the postal infrastructure. By allowing this channel of authorized communication, the infrastructure may be simplified and transactions with the infrastructure are facilitated.

With the security scheme of this application, a separate security server to authenticate users coming into infrastructure is not needed. The service provider has their own set of keys that has been assigned by the infrastructure and this key is used to generate a session key.

### SUMMARY OF THE EXEMPLARY EMBODIMENTS

In one aspect of this invention, a system for providing postal services includes one or more networks, associated with one or more postal security devices (PSD), and a postal infrastructure connected to the PSDs through the one or more of the networks, wherein service providers are provided with the means to authorize access to the postal infrastructure and central data center and establish communication with the one or more PSDs as required for supplying postal services.

In another aspect of this invention, a PSD may initiate a communication by accessing a postal services provider server over the Internet. A vendor infrastructure server provides the security identifiers or keys for a particular customer and PSD to the service provider server. In addition a security algorithm is also provided to the service provider from the infrastructure.

In another aspect of this invention, when a customer initiates communication to obtain postal services from the service provider, a security algorithm directs the service provider server to generate a session key. The session key includes the user name, the user service provider name, the time that this key was generated, and a digital signature over these items. The session key also includes a time limit, after which the session key expires and no further use of that particular session key may used. As part of this process, a common time reference is provided for the cooperating computer servers.

Once a session key is issued, the customer is allowed to order services, including the downloading of funds, PSD account servicing, software, advertising and others. Once a transaction is completed and the appropriate account billed through the data center, the customer may activate the purchased service at its convenience at the service provider.

### BRIEF DESCRIPTION OF THE DRAWINGS

The foregoing aspects and other features of the disclosed embodiments are explained in the following description, taken in connection with the accompanying drawings, wherein:

FIG. 1 shows a block diagram of a system suitable for practicing the disclosed embodiments;

FIG. 2 shows a block diagram of a typical postal security device; and

FIG. 3 shows a flow diagram of the security scheme of the disclosed embodiments.

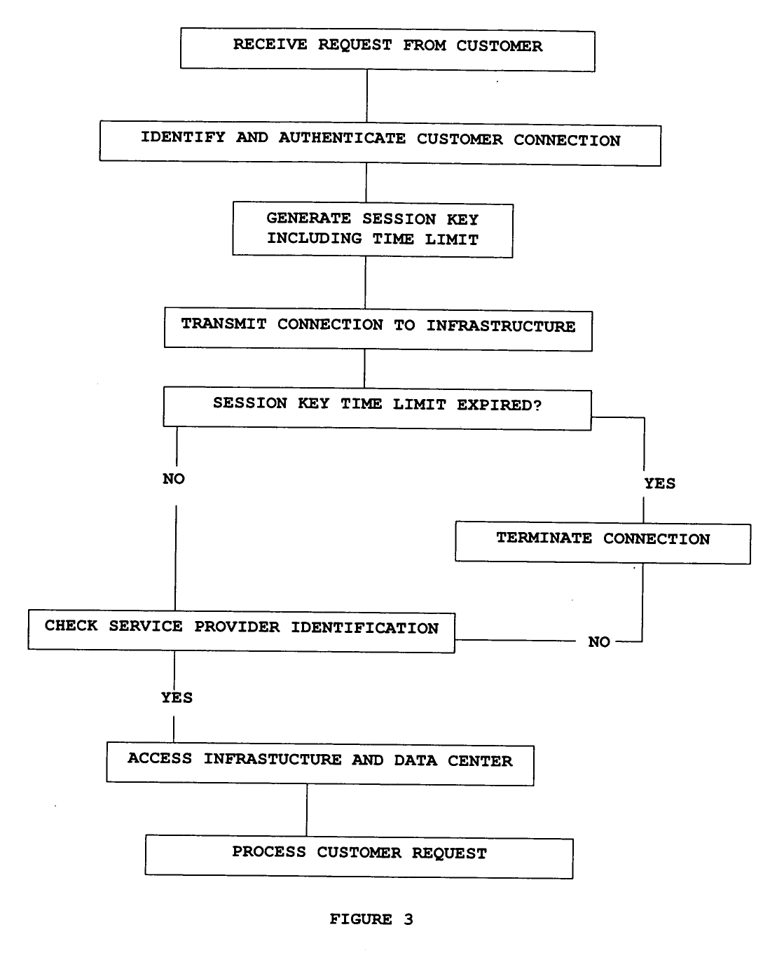

### DETAILED DESCRIPTION OF THE PREFERRED EMBODIMENTS

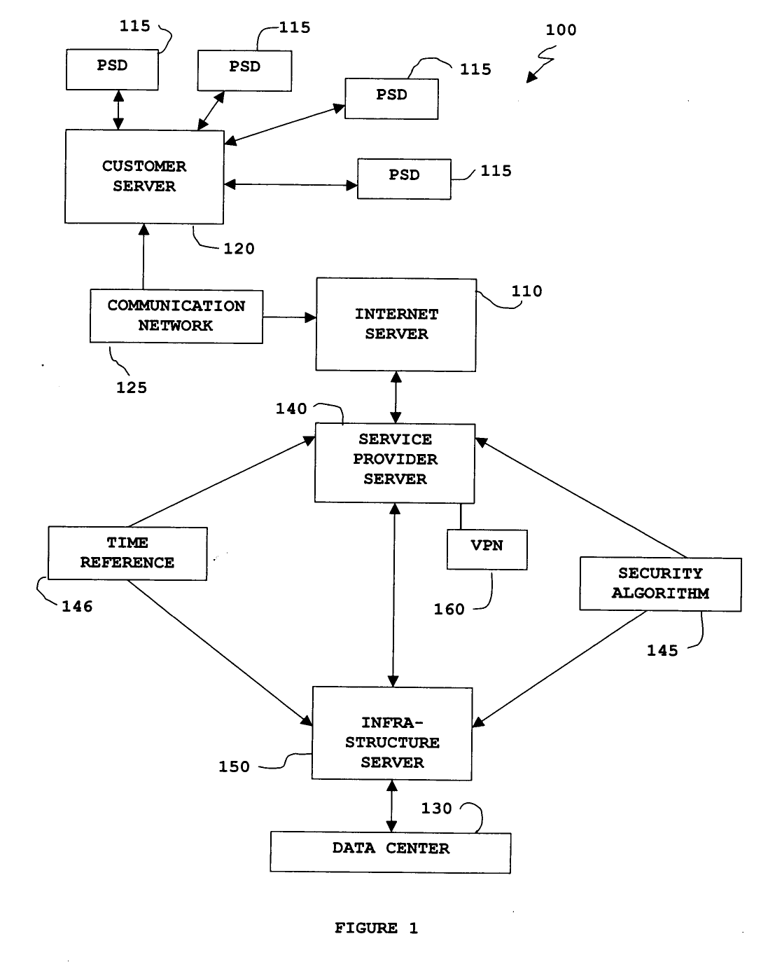

FIG. 1 shows a block diagram of a system 100 suitable for practicing the disclosed embodiments disclosed herein. Although the disclosed embodiments will be described with reference to the embodiment shown in the drawings, it should be understood that the disclosed embodiments can be in many alternate forms. In addition, any suitable size, shape or type of elements or materials could be used.

System 100 includes one or more funding devices, shown in FIG. 1 as PSDs 115 and a postal data center 130. PSDs 115 are connected to data center 130 through one or more networks, such as network 125.

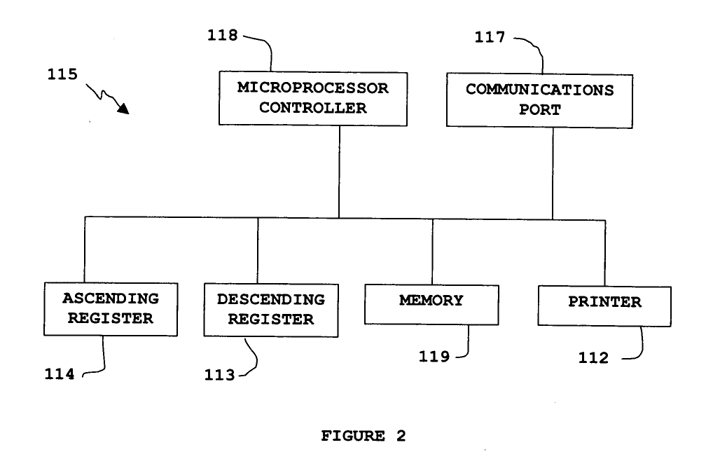

FIG. 2 shows a general block diagram of PSD 115. PSD 115 may include a communications port 117 and a microprocessor 118 for performing electronic accounting functions, control functions, and franking functions according to programs stored in a storage device 119. Some of these functions or subsets of these functions may be grouped within a secure enclosure.

The franking functions performed by PSD 115 typically include providing an indication, funds, or other authorization to produce indicia, and reporting the number of items, value marked and other parameters to the accounting functions. Such indication, funds, or other authorization are referred to herein as indicia services.

As shown in FIG. 2, a typical PSD includes a microprocessor controller 118 that controls the operation of the PSD 115. Memory 119 stores software and other data used in the printing of indicia. Current account information is tracked by ascending and descending registers 114 and 113 respectively. A printer 112 applies the postal indicia to the item for posting. The control functions performed by a PSD 115 may also include utilizing communications port 117 to communicate with the data center 130. Communications port 117 generally includes an antenna and support circuitry or other signaling devices for communicating with the postal infrastructure data center 130 through the one or more networks 125, as shown in FIG. 1.

Communications may be provided through an air interface, a wired interface, a wireless interface, or an electrical, electromagnetic, radio, infrared, or other suitable facility for communication.

The data center 130 generally has the capability to communicate with one or more of the PSDs 115 to exchange information as required. For example, to download additional features, updates, upgrades, programs, diagnostic functions, delivery confirmation or other types of information or further to retrieve information including accounting data, status data, etc.

In some instances a customer operator of a network of PSDs 115 may require services in addition to indicia related services, for example, a vendor may make available advertising, software, order processing, funds downloading and other types of services. Such services may be provided by the original equipment manufacture (OEM) or other third party vendors and distributors, referred to herein as vendors. In such instances it is advantageous to have a system through which the vendors may authorize access to the communication infrastructure 150 for accounting at the data center 130.

To accomplish this, in one embodiment of this invention, a service provider server 140, at the vendor, is constructed for receiving customer inquiries from customer server 120 through network 125 and relating to a particular PSDs 115. As shown in FIG. 1, customer network 125 provides communication services to multiple PSDs 115 of customer server 120. In the embodiment shown, communication is provided by using an internet browser at an Internet server 110. Service provider server 140 allows Internet access to obtain indicia and other services. Since, according to this embodiment, such access may include private information, the service provider must identify the customer, authenticate the communication, and authorize access to data center 130 through postal infrastructure 150.

According to an embodiment of this invention, a customer, in order to obtain services, may logon or establish a connection through a particular communications network 125 to Internet server 110 by addressing a message specifically to the service provider.

Communication network 125 may include any suitable communications network, for example, the Public Switched Telephone Network (PSTN), a wireless network, a wired network, a Local Area Network (LAN), a Wide Area Network (WAN), virtual private network (VPN), an air interface, etc. The air interface may include any suitable wireless communication protocols or signaling techniques or standards, for example TDMA, CDMA, IEEE 802.11, Bluetooth, close range RF, optical, any appropriate satellite communication standards, etc.

Infrastructure server 150 is constructed to provide user services for customers via a service provider 140. As indicated above, in the illustrated embodiment, a web browser is used to connect via Internet server 110 to the infrastructure 150, via the customer's respective service provider server 140. The service provider is likely to be the vendor or distributor of the PSD 115. Once the access to the infrastructure 150 is obtained, the customer will have access to account information for obtaining funds, authorizing the application of postal indicia, and additional services as available. This requires a security scheme executed by the service provider to identify whoever is accessing the infrastructure 150. It is, therefore, the responsibility of the service provider to authenticate its customers and permit access to the infrastructure 150. Infrastructure 150 need only verify the authenticity of the service provider to permit the connection.

To accomplish this, the connection between the customer server 120 and service provider server 140 is accomplished via communication network 125 and the Internet server 110 and routed to the infrastructure 150 through a virtual private network (VPN) 160 comprising software module 160 operating on the service provider server 110. VPN 160 provides encryption for point to point connections. Authentication of the “end user” is accomplished by executing a security algorithm 145. This provides the interface between the customer 120 and the service provider 140 via the postal infrastructure 150.

In the system of this application, a requested connection is identified by a certificate at the service provider server 140 using public/private key algorithms which are part of a security algorithm 145. As part of this process, the service provider generates a session key so that the user can get into the infrastructure 150 for access to data center 130. The session key includes a time limit, for example, 10 minutes, after which the session key expires. This prevents an unauthorized user from gaining access to the infrastructure 150 by reusing a session key.

The session key includes the user name, the user service provider name, the time that this key was generated, and a digital signature on these items. This enables the authentication of the customer via the credentials provided (user name, service provider name, time stamp, digital signature). At the service provider server 140, the validation of a signature is based on the service provider's public key. The infrastructure server 150 generates the keys which the service provider uses to generate the session key.

With the security scheme of this application, a separate server to marshal the keys and to authenticate users coming into infrastructure server 140 is not needed. The service provider has their own set of keys that has been assigned by the infrastructure server 150 and these keys are used to generate a session key. Once a user is authenticated by the service provider, the session key within the session identification is passed back and forth during the session communications.

As part of this scheme, all the participating processors and servers must be in time synchronization. This is accomplished by using Greenwich Mean Time (GMT) relative to the session time limit. The security algorithm 145 is, therefore, adaptable to any service provider or user location. In this manner fraudulent alteration of the timing reference is prevented, since the system clock is supplied by a separate entity. The clock reference may be obtained through a government generated system available from several sources, for example the Global Position Satellite constellation. In this manner, the integrity of the session key time limit remains secure.

In operation the service provider 140 receives a request from a customer 120 and initiates authentication of the request by checking the customer identification and applying related security keys. This is accomplished by executing a security algorithm 145 within a VPN 160 on the service provider server 140. If the request is authenticated the service provider generates a session key, including a time limit after which the session key will expire. Conditioned on authentication, the customer request is transmitted, with the session key, to the postal infrastructure connected to a data center. If the session key time limit has not expired, the service provider is validated based on a public key assigned to the service provider. If validation is successfully completed, the customer request is processed in cooperation with data center 130.

It should be understood that the foregoing description is only illustrative of the disclosed embodiments. Various alternatives and modifications can be devised by those skilled in the art without departing from the disclosed embodiments. Accordingly, the disclosed embodiments is intended to embrace all such alternatives, modifications and variances which fall within the scope of the appended claims.

What is claimed is:

1. A system for providing postal and other services to postal security devices (PSDs) comprising:
one or more networks connected to one or more customer servers;
one or more PSDs connected to a communication system through the one or more networks;
an infrastructure server for providing access to a data center containing accounting and other data relative to the operation of the one or more PSDs;
a service provider server accessible to the one or more networks to provide postal and other services to the one or more PSDs, wherein the service provider server further comprises a security software module having a security algorithm for execution by the service provider server, to allow authentication of a connection to one or more of the PSDs for the purpose of obtaining services and accessing the data center.

2. The system according to claim 1 wherein the security software module comprises a virtual private network.

3. The system according to claim 1, wherein the communication system establishes a connection to the service provider server through an Internet server.

4. The system according to claim 1, wherein the security algorithm causes the service provider server to generate a session key, the session key including a time limit, the session key terminating upon the expiration of the time limit.

5. The system, according to claim 4, wherein the session key further comprises a user name, a user service provider name, a time that this key was generated, and a digital signature on these items.

6. The system, according to claim 1, wherein the validation of a connection is based on a public key assigned to the service provider.

7. The system, according to claim 4, wherein the service provider server, infrastructure server, and customer server operate with a common time reference.

8. The system, according to claim 7, wherein the common time reference comprises signals from GPS satellite constellation.

9. A method of processing a postal customer request for services through a service provider comprising the steps of:
receiving a request from a customer at the service provider;
authenticating the request at the service provider;
generating a session key at the service provider, including a time limit after which the session key expires;
transmitting the customer request with the session key to a postal infrastructure connected to a data center;
checking session key time limit at the postal infrastructure and terminating connection if expired;
validating the service provider at the postal infrastructure; and
processing the customer request.

10. The method according to claim 9 wherein the step of authenticating the customer request is processed by a virtual private network.

11. The method according to claim 9, wherein the customer establishes a connection to the service provider through an Internet server.

12. The method according to claim 9, wherein the step of authenticating the customer request comprises the execution of a security algorithm that causes the service provider server to generate a session key, the session key including a time limit, the session key terminating upon the expiration of the time limit.

13. The method, according to claim 9, wherein the session key further comprises a user name, a user service provider name, a time that this key was generated, and a digital signature on these items.

14. The method, according to claim 9, wherein the step of validating the service provider is based on a public key assigned to the service provider.

15. The method, according to claim 9, further comprising the step of providing a common time reference to the service provider, infrastructure, and customer.

16. The method, according to claim 15, wherein the common time reference comprises signals from GPS satellite constellation.
